(19) United States
(12) Patent Application Publication
(10) Pub. No.: US 2026/0319858 A1
(43) Pub. Date: Oct. 15, 2026

(54) METHOD AND APPARATUS FOR RESOURCE MANAGEMENT FOR INFERENCE BASED ON ARTIFICIAL INTELLIGENCE AND MACHINE LEARNING

(71) Applicant: Electronics and Telecommunications Research Institute, Daejeon (KR)

(72) Inventors: Anseok LEE, Daejeon (KR); Yong Jin KWON, Daejeon (KR); Seungjae BAHNG, Daejeon (KR); Youngjoon YOON, Daejeon (KR); Heesoo LEE, Daejeon (KR); Yunjoo KIM, Daejeon (KR); Hyun Seo PARK, Daejeon (KR); Jungsook BAE, Daejeon (KR); Jungbo SON, Daejeon (KR); Yu Ro LEE, Daejeon (KR)

(21) Appl. No.: 19/644,996

(22) Filed: Apr. 10, 2026

(30) Foreign Application Priority Data
Apr. 10, 2025 (KR) 10-2025-0046699
Apr. 8, 2026 (KR) 10-2026-0063281

(51) Int. Cl. G06F 9/50; G06F 9/48; G06N 5/04

(52) U.S. Cl. CPC G06F 9/5055; G06F 9/4818; G06F 9/5016; G06F 9/5022; G06N 5/04; G06F 2209/503

(57) ABSTRACT

A method of a terminal may comprise: receiving, from a base station, an AI/ML-based inference operation request for at least one intelligent functionality; determining whether inference for the at least one intelligent functionality is performable based on the AI/ML-based inference operation request; allocating at least one resource for performing the inference based on a determination that the inference is performable; receiving at least one reference signal from the base station; performing an AI/ML-based inference operation using the allocated at least one resource based on the reference signal; and reporting a result of the AI/ML-based inference operation to the base station.

### CROSS-REFERENCE TO RELATED APPLICATIONS

This application claims priority to Korean Patent Applications No. 10-2025-0046699, filed on Apr. 10, 2025, and No. 10-2026-0063281, filed on Apr. 08, 2026, with the Korean Intellectual Property Office (KIPO), the entire contents of which are hereby incorporated by reference.

### BACKGROUND

### 1. Technical Field

The present disclosure relates to an artificial intelligence/machine learning (AI/ML) technique for a communication network, and more particularly, to a method and an apparatus for resource management for AI/ML based inference.

### 2. Related Art

With the development of information and communication technology, various wireless communication technologies have been developed. Typical wireless communication technologies include long term evolution (LTE) and new radio (NR), which are defined in the 3rd generation partnership project (3GPP) standards. The LTE may be one of 4th generation (4G) wireless communication technologies, and the NR may be one of 5th generation (5G) wireless communication technologies.

For the processing of rapidly increasing wireless data after the commercialization of the 4th generation (4G) communication system (e.g., Long Term Evolution (LTE) communication system or LTE-Advanced (LTE-A) communication system), the 5th generation (5G) communication system (e.g., new radio (NR) communication system) that uses a frequency band (e.g., a frequency band of 6 GHz or above) higher than that of the 4G communication system as well as a frequency band of the 4G communication system (e.g., a frequency band of 6 GHz or below) is being considered. The 5G communication system may support enhanced Mobile BroadBand (eMBB), Ultra-Reliable and Low-Latency Communication (URLLC), and massive Machine Type Communication (mMTC).

Recently, research has been actively conducted to utilize intelligent technologies based on artificial intelligence (AI) or machine learning (ML) in communication systems. The AI/ML-based intelligent technologies may be used in fields such as enhancement of channel state information (CSI) feedback, beam management, or improvement of positioning accuracy.

A base station or a terminal of a communication system may include dedicated processor(s) for performing intelligent functionalities according to the above-described AI/ML-based intelligent technologies (e.g., AI/ML-dedicated processors such as a graphics processing unit (GPU) or a neural processing unit (NPU)). However, the AI/ML-dedicated processor may have limitations in processing speed or memory size, and thus AI/ML-based inference performance for the intelligent functionality may be degraded. Accordingly, there is a need for a method capable of ensuring performance of AI/ML-based inference using the dedicated processors.

### SUMMARY

The present disclosure for resolving the above-described problems is directed to providing a method and an apparatus for resource management of AI/ML based inference.

According to a first exemplary embodiment of the present disclosure, a method of a terminal may comprise: receiving, from a base station, an artificial intelligence/machine learning (AI/ML)-based inference operation request for at least one intelligent functionality; determining whether inference for the at least one intelligent functionality is performable based on the AI/ML-based inference operation request; allocating at least one resource for performing the inference based on a determination that the inference is performable; receiving at least one reference signal from the base station; performing an AI/ML-based inference operation using the allocated at least one resource based on the reference signal; and reporting a result of the AI/ML-based inference operation to the base station.

The determining of whether the inference is performable may comprise: comparing a required number of AI/ML processing units (APUs) for performing the inference with a number of currently available APUs based on the AI/ML-based inference operation request; and determining that the inference for the at least one intelligent functionality is performable based on the required number of APUs being less than or equal to the number of currently available APUs.

The allocating of the at least one resource may comprise: allocating, from among the currently available APUs, the required number of APUs as a resource for performing the inference; and increasing an APU occupancy based on the allocated resource.

The determining of whether the inference is performable may comprise: comparing a required AI/ML memory unit (AMU) occupancy for performing the inference with a currently available AMU occupancy based on the AI/ML-based inference operation request; and determining that loading of at least one AI/ML model parameter for the at least one intelligent functionality is performable based on the required AMU occupancy being less than or equal to the currently available AMU occupancy.

The allocating of the at least one resource may comprise: allocating, from the currently available AMU occupancy, the required AMU occupancy as a resource for performing the inference; loading the at least one AI/ML model parameter into an AMU based on the allocated resource; and increasing an AMU occupancy based on the allocated resource.

The determining of whether the inference is performable may comprise: comparing a required number of CSI processing units (C-PUs) for performing the inference with a number of currently available C-PUs based on the AI/ML-based inference operation request; and determining that the inference for the at least one intelligent functionality is performable based on the required number of C-PUs being less than or equal to the number of currently available C-PUs.

The allocating of the at least one resource may comprise: allocating, from among the currently available C-PUs, the required number of C-PUs as a resource for performing the inference; and increasing a C-PU occupancy based on the allocated resource.

The determining of whether the inference is performable may comprise: comparing a priority of the AI/ML-based inference operation request with a priority of an inference operation currently being performed; and determining that the inference according to the AI/ML-based inference operation request is performable based on the priority of the AI/ML-based inference operation request being higher than the priority of the inference operation currently being performed.

The method may further comprise: reporting terminal capability information to the base station, wherein the terminal capability information may include at least one of information on a total number of APUs, information on a total number of C-PUs, information on a total number of AMUs, or intelligent functionality-specific resource requirement information.

The method may further comprise, after reporting the result of the inference operation to the base station: releasing the at least one resource; and increasing a currently available resource occupancy based on the released at least one resource.

According to a second exemplary embodiment of the present disclosure, a terminal may comprise at least one processor, and the at least one processor may cause the terminal to perform: receiving, from a base station, an artificial intelligence/machine learning (AI/ML)-based inference operation request for at least one intelligent functionality; determining whether inference for the at least one intelligent functionality is performable based on the AI/ML-based inference operation request; allocating at least one resource for performing the inference based on a determination that the inference is performable; receiving at least one reference signal from the base station; performing an AI/ML-based inference operation using the allocated at least one resource based on the reference signal; and reporting a result of the AI/ML-based inference operation to the base station.

In the determining of whether the inference is performable, the at least one processor may cause the terminal to perform: comparing a required number of AI/ML processing units (APUs) for performing the inference with a number of currently available APUs based on the AI/ML-based inference operation request; and determining that the inference for the at least one intelligent functionality is performable based on the required number of APUs being less than or equal to the number of currently available APUs.

In the allocating of the at least one resource, the at least one processor may cause the terminal to perform: allocating, from among the currently available APUs, the required number of APUs as a resource for performing the inference; and increasing an APU occupancy based on the allocated resource.

In the determining of whether the inference is performable, the at least one processor may cause the terminal to perform: comparing a required AI/ML memory unit (AMU) occupancy for performing the inference with a currently available AMU occupancy based on the AI/ML-based inference operation request; and determining that loading of at least one AI/ML model parameter for the at least one intelligent functionality is performable based on the required AMU occupancy being less than or equal to the currently available AMU occupancy.

In the allocating of the at least one resource, the at least one processor may cause the terminal to perform: allocating, from the currently available AMU occupancy, the required AMU occupancy as a resource for performing the inference; loading the at least one AI/ML model parameter into an AMU based on the allocated resource; and increasing an AMU occupancy based on the allocated resource.

In the determining of whether the inference is performable, the at least one processor may cause the terminal to perform: comparing a required number of CSI processing units (C-PUs) for performing the inference with a number of currently available C-PUs based on the AI/ML-based inference operation request; and determining that the inference for the at least one intelligent functionality is performable based on the required number of C-PUs being less than or equal to the number of currently available C-PUs.

In the allocating of the at least one resource, the at least one processor may cause the terminal to perform: allocating, from among the currently available C-PUs, the required number of C-PUs as a resource for performing the inference; and increasing a C-PU occupancy based on the allocated resource.

In the determining of whether the inference is performable, the at least one processor may cause the terminal to perform: comparing a priority of the AI/ML-based inference operation request with a priority of an inference operation currently being performed; and determining that the inference according to the AI/ML-based inference operation request is performable based on the priority of the AI/ML-based inference operation request being higher than the priority of the inference operation currently being performed.

The at least one processor may further cause the terminal to perform: reporting terminal capability information to the base station, wherein the terminal capability information may include at least one of information on a total number of APUs, information on a total number of C-PUs, information on a total number of AMUs, or intelligent functionality-specific resource requirement information.

The at least one processor may further cause the terminal to perform, after reporting the result of the inference operation to the base station: releasing the at least one resource; and increasing a currently available resource occupancy based on the released at least one resource.

According to the present disclosure, a terminal may determine whether it is possible to perform inference in consideration of a resource state of the terminal based on an AI/ML-based inference operation request received from a base station. Accordingly, the terminal can efficiently manage terminal resources for AI/ML-based inference and may improve accuracy and reliability of performing the inference operation.

### BRIEF DESCRIPTION OF DRAWINGS

FIG. 1 is a conceptual diagram illustrating exemplary embodiments of a communication system.

FIG. 2 is a block diagram illustrating exemplary embodiments of a communication node constituting a communication system.

FIG. 3 is a conceptual diagram illustrating an exemplary embodiment of intelligent beam management of a communication network.

FIG. 4 is a conceptual diagram illustrating an exemplary embodiment of intelligent positioning of a communication network.

FIG. 5 is a conceptual diagram illustrating an exemplary embodiment of intelligent channel information feedback of a communication network.

FIG. 6 is a block diagram illustrating an exemplary embodiment of a configuration for an AI/ML-based inference operation of a terminal.

FIG. 7 is a sequence diagram illustrating an exemplary embodiment of a resource management method for an AI/ML-based inference operation of a terminal.

FIG. 8 is a conceptual diagram illustrating an exemplary embodiment of a change in APU occupancy according to an AI/ML-based inference operation of a terminal.

FIG. 9 is a sequence diagram illustrating another exemplary embodiment of a resource management method for an AI/ML-based inference operation of a terminal.

FIG. 10 is a conceptual diagram illustrating an exemplary embodiment of a change in AMU occupancy according to an AI/ML-based inference operation of a terminal.

FIG. 11 is a sequence diagram illustrating another exemplary embodiment of a resource management method for an AI/ML-based inference operation of a terminal.

### DETAILED DESCRIPTION OF THE EMBODIMENTS

Exemplary embodiments of the present disclosure are disclosed herein. However, specific structural and functional details disclosed herein are merely representative for purposes of describing embodiments of the present disclosure. Thus, embodiments of the present disclosure may be embodied in many alternate forms and should not be construed as limited to embodiments of the present disclosure set forth herein.

Accordingly, while the present disclosure is capable of various modifications and alternative forms, specific embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

A communication network to which exemplary embodiments according to the present disclosure are applied will be described. The communication network may be a non-terrestrial network (NTN), a 4G communication network (e.g., Long-Term Evolution (LTE) communication network), a 5G communication network (e.g., New Radio (NR) communication network), or a B5G mobile communication network (e.g., 6G mobile communication network). The 4G communication network and the 5G communication network may be classified as terrestrial networks.

In exemplary embodiments, “an operation (e.g., transmission operation) is configured” may mean that “configuration information (e.g., information element(s) or parameter(s)) for the operation and/or information indicating to perform the operation is signaled”. “Information element(s) (e.g., parameter(s)) are configured” may mean that “corresponding information element(s) are signaled”. The signaling may be at least one of system information (SI) signaling (e.g., transmission of system information block (SIB) and/or master information block (MIB)), RRC signaling (e.g., transmission of RRC parameters and/or higher layer parameters), MAC control element (CE) signaling, or PHY signaling (e.g., transmission of downlink control information (DCI), uplink control information (UCI), and/or sidelink control information (SCI)).

In the present disclosure, even when a method (e.g., transmission or reception of a signal) performed at a first communication node among communication nodes is described, a corresponding second communication node may perform a method (e.g., reception or transmission of the signal) corresponding to the method performed at the first communication node. That is, when an operation of a terminal is described, a base station corresponding to the terminal may perform an operation corresponding to the operation of the terminal. Conversely, when an operation of a base station is described, a terminal corresponding to the base station may perform an operation corresponding to the operation of the base station. In addition, when an operation of a first terminal is described, a second terminal corresponding to the first terminal may perform an operation corresponding to the operation of the first terminal. Conversely, when an operation of a second terminal is described, a first terminal corresponding to the second terminal may perform an operation corresponding to the operation of the second terminal.

Throughout the present disclosure, a terminal may refer to a mobile station, mobile terminal, subscriber station, portable subscriber station, user equipment, access terminal, or the like, and may include all or a part of functions of the terminal, mobile station, mobile terminal, subscriber station, mobile subscriber station, user equipment, access terminal, or the like.

Here, a desktop computer, laptop computer, tablet PC, wireless phone, mobile phone, smart phone, smart watch, smart glass, e-book reader, portable multimedia player (PMP), portable game console, navigation device, digital camera, digital multimedia broadcasting (DMB) player, digital audio recorder, digital audio player, digital picture recorder, digital picture player, digital video recorder, digital video player, or the like having communication capability may be used as the terminal.

Throughout the present disclosure, the base station may refer to an access point, radio access station, node B (NB), evolved node B (eNB), base transceiver station, mobile multihop relay (MMR)-BS, or the like, and may include all or part of functions of the base station, access point, radio access station, NB, eNB, base transceiver station, MMR-BS, or the like.

Hereinafter, preferred exemplary embodiments of the present disclosure will be described in more detail with reference to the accompanying drawings. In describing the present disclosure, in order to facilitate an overall understanding, the same reference numerals are used for the same elements in the drawings, and duplicate descriptions for the same elements are omitted.

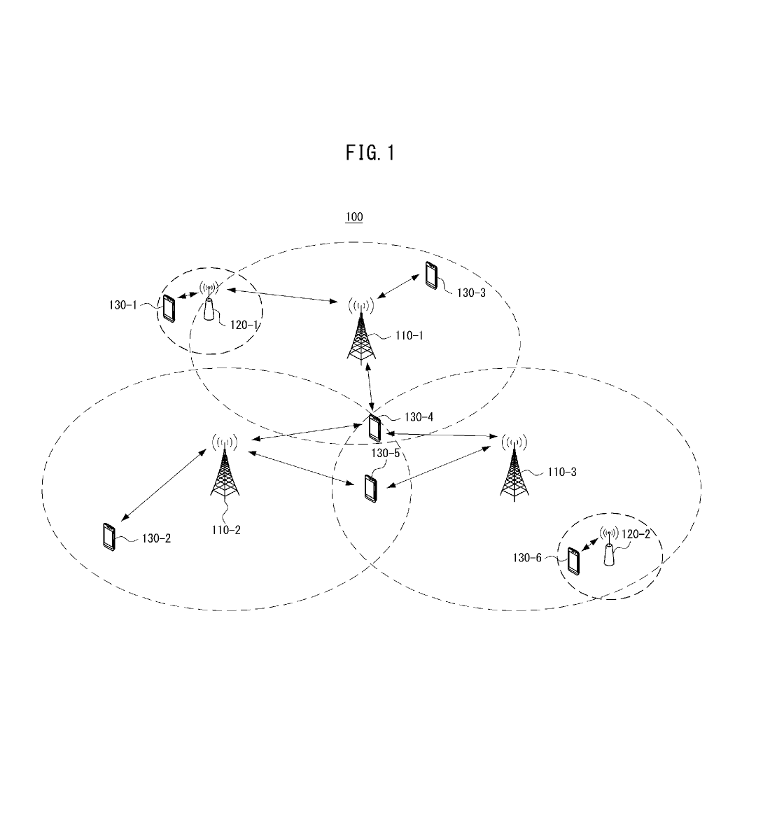

FIG. 1 is a conceptual diagram illustrating exemplary embodiments of a communication system.

Referring to FIG. 1, a communication system 100 may comprise a plurality of communication nodes 110-1, 110-2, 110-3, 120-1, 120-2, 130-1, 130-2, 130-3, 130-4, 130-5, and 130-6. The plurality of communication nodes 110-1, 110-2, 110-3, 120-1, 120-2, 130-1, 130-2, 130-3, 130-4, 130-5,and 130-6 may include a plurality ofbase stations 110-1, 110-2, 110-3, 120-1,and 120-2)and a plurality of terminals, for example, a plurality of user terminals 130-1, 130-2, 130-3, 130-4, 130-5, and 130-6.

Each of the plurality of communication nodes 110-1, 110-2, 110-3, 120-1, 120-2, 130-1, 130-2, 130-3, 130-4, 130-5, and 130-6 may support 4G communication (e.g., long term evolution (LTE), LTE-advanced (LTE-A)), 5G communication (e.g., new radio (NR)), 6G communication, etc. specified in the 3rd generation partnership project (3GPP) standards. The 4G communication may be performed in frequency bands below 6GHz, and the 5G and 6G communication may be performed in frequency bands above 6GHz as well as frequency bands below 6GHz.

For example, in order to perform the 4G communication, 5G communication, and 6G communication, the plurality of communication nodes may support a code division multiple access (CDMA) based communication protocol, wideband CDMA (WCDMA) based communication protocol, time division multiple access (TDMA) based communication protocol, frequency division multiple access (FDMA) based communication protocol, orthogonal frequency division multiplexing (OFDM) based communication protocol, filtered OFDM based communication protocol, cyclic prefix OFDM (CP-OFDM) based communication protocol, discrete Fourier transform spread OFDM (DFT-s-OFDM) based communication protocol, orthogonal frequency division multiple access (OFDMA) based communication protocol, single carrier FDMA (SC-FDMA) based communication protocol, non-orthogonal multiple access (NOMA) based communication protocol, generalized frequency division multiplexing (GFDM) based communication protocol, filter bank multi-carrier (FBMC) based communication protocol, universal filtered multi-carrier (UFMC) based communication protocol, space division multiple access (SDMA) based communication protocol, orthogonal time-frequency space (OTFS) based communication protocol, or the like.

Further, the communication system 100 may further include a core network (not shown). When the communication 100 supports 4G communication, the core network may include a serving gateway (S-GW), packet data network (PDN) gateway (P-GW), mobility management entity (MME), and the like. When the communication system 100 supports 5G communication or 6G communication, the core network may include a user plane function (UPF), session management function (SMF), access and mobility management function (AMF), and the like.

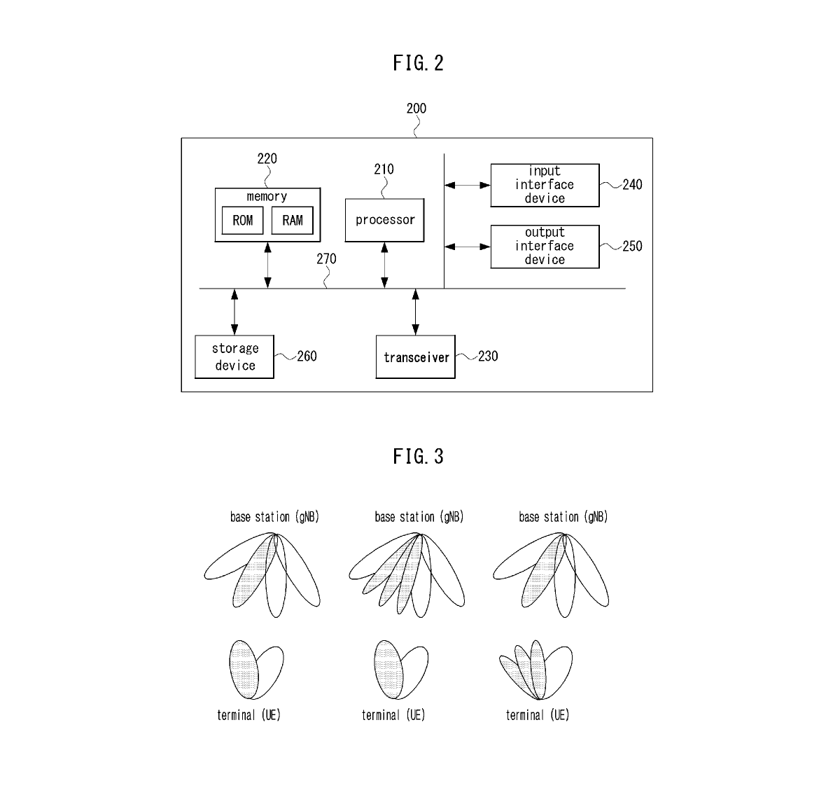

FIG. 2 is a block diagram illustrating exemplary embodiments of a communication node constituting a communication system.

Referring to FIG. 2, a communication node 200 may comprise at least one processor 210, a memory 220, and a transceiver 230 connected to the network for performing communications. Also, the communication node 200 may further comprise an input interface device 240, an output interface device 250, a storage device 260, and the like. Each component included in the communication node 200 may communicate with each other as connected through a bus 270.

However, each component included in the communication node 200 may not be connected to the common bus 270 but may be connected to the processor 210 via an individual interface or a separate bus. For example, the processor 210 may be connected to at least one of the memory 220, the transceiver 230, the input interface device 240, the output interface device 250 and the storage device 260 via a dedicated interface.

The processor 210 may execute a program stored in at least one of the memory 220 and the storage device 260. The processor 210 may refer to a central processing unit (CPU), a graphics processing unit (GPU), or a dedicated processor on which methods in accordance with embodiments of the present disclosure are performed.

Each of the memory 220 and the storage device 260 may be constituted by at least one of a volatile storage medium and a non-volatile storage medium. For example, the memory 220 may comprise at least one of read-only memory (ROM) and random access memory (RAM).

The communication node 200 may include an intelligent model (e.g., AI/ML model) for performing an intelligent function based on AI/ML. The AI/ML model may be classified into a one-sided model and a two-sided model. The one-sided model may be a type in which one of a base station and a terminal among a plurality of communication nodes includes an AI/ML model. The two-sided model may be a type in which each of a base station and a terminal among a plurality of communication nodes includes an AI/ML model.

The communication node 200 may perform life cycle management (LCM) for an AI/ML model, such as for intelligent functionality, model creation, or model maintenance. The LCM may include detailed stages such as data collection, model training, model inference, model deployment, model activation, model deactivation, model selection, model switching, model fallback, and model monitoring.

The communication node 200 may identify an intelligent functionality supported by the communication network 100, or may identify an AI/ML model performing an intelligent functionality. For example, the base station may identify an intelligent functionality or AI/ML model supported by the terminal, and the base station may instruct the terminal to perform activation of a specific intelligent functionality or AI/ML model based on the identified intelligent functionality or AI/ML model.

The communication node 200 may perform LCM for an AI/ML model based on intelligent functionality identification or AI/ML model identification. For example, the communication node 200 may perform functionality-based LCM for the AI/ML model, or the communication node 200 may perform model ID-based LCM for the AI/ML model. The functionality-based LCM may be a process in which the base station and the terminal share functionality information for an intelligent functionality in advance and identify and manage the intelligent functionality based on the shared functionality information. The model ID-based LCM may be a process in which the base station and the terminal share model information together with a model ID in advance and identify and manage an AI/ML model based on the shared model information and the model ID.

As described above, the communication network 100 may perform a specific intelligent functionality using an AI/ML model included in at least one among the plurality of communication nodes 110-1, 110-2, 110-3, 120-1, 120-2, 130-1, 130-2, 130-3, 130-4, 130-5, and 130-6. The specific intelligent functionality may include intelligent channel state information (CSI) feedback enhancement, intelligent positioning enhancement, or intelligent beam management in the communication network 100.

FIG. 3 is a conceptual diagram illustrating an exemplary embodiment of intelligent beam management of a communication network.

Referring to FIG. 3, an intelligent functionality using an AI/ML model may be applied to a beam management method that may improve a reach of a directional beam in a communication network.

For example, when directional beams are used in the communication network, a process of selecting a base station beam (Tx beam) and a terminal beam (Rx beam) that provide optimal performance among a plurality of beams may be required for stable link performance between a base station and a terminal. A conventional beam management method for selecting an optimal beam may cause problems such as performance degradation or increase in power consumption due to frequent signaling overhead.

The beam management method to which the intelligent functionality is applied may reduce overhead generated in beam measurement for selecting an optimal beam and may improve accuracy of optimal beam selection. The beam management method to which the intelligent functionality is applied may perform beam prediction for predicting a beam corresponding to a resource that is not observed in the spatial domain or the temporal domain.

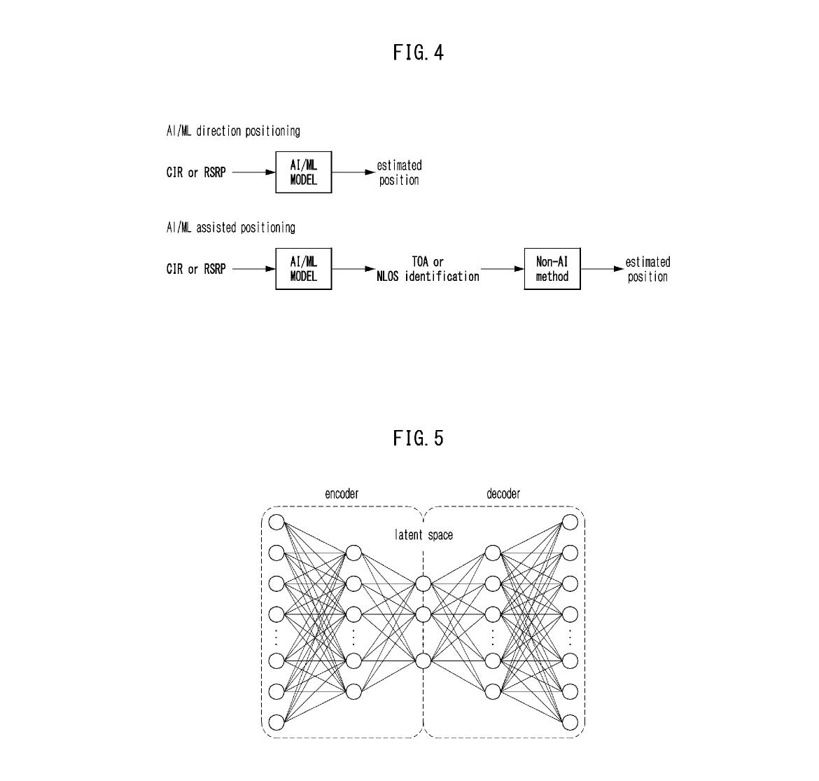

FIG. 4 is a conceptual diagram illustrating an exemplary embodiment of intelligent positioning of a communication network.

Referring to FIG. 4, an intelligent functionality using an AI/ML model may be applied to a method of improving positioning accuracy for estimating a position of a specific terminal in a communication network.

The positioning accuracy improvement method to which the intelligent functionality is applied may include a direct AI/ML positioning method using an AI/ML model or an AI/ML assisted positioning method. The direct positioning method may be a method in which an AI/ML model receives channel impulse responses (CIRs) or reference signal received powers (RSRPs) as inputs and outputs an estimated position of the terminal. The assisted positioning method may be a method in which an AI/ML model receives CIRs or RSRPs as inputs, outputs a time of arrival (TOA) or a non-line-of-sight (NLOS) identification result, and outputs an estimated position of the terminal based on the TOA and the non-line-of-sight identification result.

FIG. 5 is a conceptual diagram illustrating an exemplary embodiment of intelligent channel information feedback of a communication network.

Referring to FIG. 5, an intelligent functionality using an AI/ML model may be applied to a method of improving channel information feedback of a communication network. Channel information feedback (i.e., CSI feedback) refers to reporting, by a terminal, of channel state information (CSI) to a base station to enable the base station to apply a transmission technique such as multiple input multiple output (MIMO) or precoding in the communication network. The channel information feedback may support feedback information such as channel quality indication (CQI), precoding matrix indication (PMI), or rank indication (RI).

The intelligent functionality may be applied to an auto-encoder, and channel compression (CSI compression) for obtaining a compressed latent representation for a MIMO channel through the auto-encoder may be performed. For example, the auto-encoder may include an encoder, a decoder, and a hidden layer between the encoder and the decoder. The auto-encoder may set a number of neurons of the hidden layer to be smaller than that of an input layer, and data compression (or dimension reduction) may be achieved.

Referring again to FIG. 2, the communication node 200 may include at least one dedicated processor (e.g., a processor such as a graphics processing unit (GPU) or a neural processing unit (NPU)) for efficient execution of intelligent functionalities using the AI/ML model. The communication node 200 may perform an AI/ML-based inference operation using at least one dedicated processor to perform a specific intelligent functionality, or may perform an AI/ML-based inference operation using an existing processor.

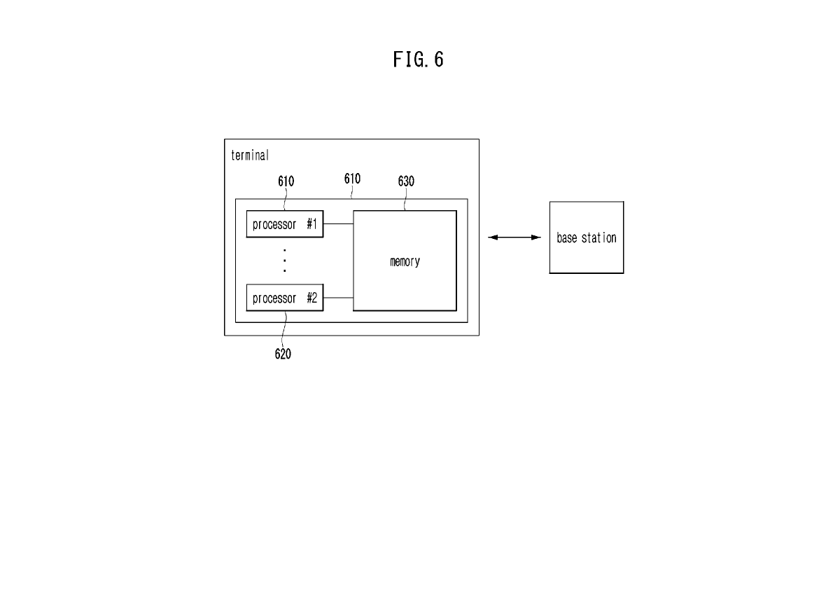

FIG. 6 is a block diagram illustrating an exemplary embodiment of a configuration for an AI/ML-based inference operation of a terminal.

Referring to FIG. 6, a terminal may include a first processor 610, a second processor 620, and a memory 630. The first processor 610 may be a general-purpose processor (e.g., CPU). The second processor 620 may be a dedicated processor for an AI/ML-based inference operation of the terminal (e.g., GPU or NPU). FIG. 6 illustrates one second processor 620, but the terminal may include a plurality of second processors.

The terminal may perform an AI/ML-based inference operation for an intelligent functionality using the second processor 620 based on a requested inference operation or activation of an intelligent functionality requested by a base station. For example, the terminal may load at least one AI/ML model parameter for the corresponding intelligent functionality into the memory 630. The second processor 620 may perform the inference operation for the corresponding intelligent functionality based on the AI/ML model parameter(s) loaded in the memory 630. According to an exemplary embodiment, the second processor 620 may include an internal memory (not shown) capable of storing AI/ML parameters. The terminal may load at least one AI/ML model parameter for the AI/ML-based inference operation into the internal memory of the second processor 620. The second processor 620 may perform the inference operation for the corresponding intelligent functionality based on the loaded AI/ML model parameters. According to an exemplary embodiment, the terminal may also perform the AI/ML-based inference operation using the first processor 610. According to an exemplary embodiment, the terminal may also perform the AI/ML-based inference operation by using the first processor 610 and the second processor 620 simultaneously.

The terminal may manage an AI/ML-based inference operation for a specific intelligent functionality using an AI/ML processing unit (APU) or an AI/ML memory unit (AMU). Here, the APU may refer to a logical processing unit including a computation function for AI/ML inference of the terminal or a function for controlling execution of the computation function. The AMU may refer to a logical processing unit including a parameter loading function for AI/ML inference of the terminal or a function for controlling execution of the parameter loading function.

According to an exemplary embodiment, the terminal may divide the entire computation resources of the second processor 620 into at least one inference operation resource required for each intelligent functionality. The terminal may configure an APU for each of the divided inference operation resources and may manage an AI/ML-based inference operation for each intelligent functionality. For example, when a total number (or size) of the entire computation resources of the second processor 620 is 100 and a number of inference operation resources required for each intelligent functionality is 20, the terminal may configure five APUs for the entire computation resources. The terminal may control execution of the AI/ML-based inference operation of the second processor 620 using the five APUs. Here, the AI/ML-based inference operation managed by each APU may include a matrix operation, a vector operation, a convolution operation, or an activation function operation. The terminal may allocate one APU to one intelligent functionality to manage execution of the inference operation, or may allocate a plurality of APUs to one intelligent functionality to control execution of the inference operation for the corresponding intelligent functionality.

According to an exemplary embodiment, the terminal may divide the entire memory resources of the memory 630 into parameter loading resources required for each intelligent functionality. The terminal may configure an AMU for each of the divided loading resources and may manage an AI/ML-based inference operation for each intelligent functionality. For example, when a total memory resource size (or capacity) of the memory 630 is 100 and a parameter loading resource size required for each intelligent functionality is 20, the terminal may configure five AMUs for the entire memory resources. The terminal may control loading of at least one AI/ML model parameter during the AI/ML-based inference operation of the second processor 620 using the five AMUs.

According to an exemplary embodiment, the terminal may divide remaining memory resources, excluding memory resources allocated to the first processor 610, among the entire memory resources of the memory 630 into parameter loading resources for each intelligent functionality. For example, a total memory resource size of the memory 630 may be 100, and a memory resource size allocated to the first processor 610 may be 20. When a parameter loading resource size required for each intelligent functionality is 20, the terminal may configure four AMUs for a memory resource size of 80 after excluding already allocated memory resources among the entire memory resources.

According to an exemplary embodiment, the terminal may perform an AI/ML-based inference operation for a specific intelligent functionality (e.g., a CSI inference operation) using the first processor 610. The terminal may manage the AI/ML-based inference operation of the first processor 610 using a CSI-processing unit (C-PU). For example, the terminal may allocate a part of the entire computation resources of the first processor 610 as at least one inference computation resource required for each intelligent functionality. The terminal may configure a C-PU for the allocated inference computation resource and may manage the AI/ML-based CSI inference operation using the C-PU.

The terminal may receive a request for an AI/ML-based inference operation for a specific intelligent functionality from a base station. The terminal may determine whether inference can be performed for an inference request received from the base station by considering inference operation constraints. The constraints may include at least one of a number of APUs that may be allocated for the AI/ML-based inference operation, a number of AMUs that may be allocated for loading the AI/ML model parameters, or a number of C-PUs that may be allocated for the AI/ML-based inference operation.

According to an exemplary embodiment, the terminal may determine whether AI/ML-based inference can be performed by comparing required APUs, AMUs, and/or C-PUs for the AI/ML-based inference of a specific intelligent functionality requested from the base station with currently available (or allocatable) APUs, AMUs, and/or C-PUs. When it is determined that the AI/ML-based inference can be performed, the terminal may allocate currently available APU(s), AMU(s), and/or C-PU(s) to the inference operation and may perform an AI/ML-based inference operation for the corresponding intelligent functionality. The terminal may report an AI/ML-based inference result to the base station. Also, when it is determined that the inference operation is not possible, the terminal may not perform the AI/ML-based inference for the corresponding intelligent functionality and may transmit information indicating this to the base station.

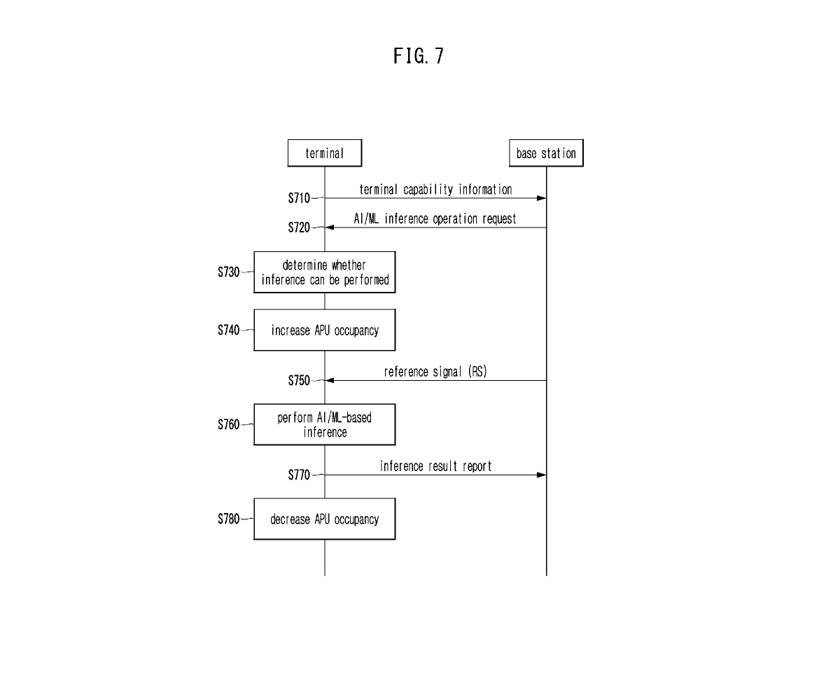

FIG. 7 is a sequence diagram illustrating an exemplary embodiment of a resource management method for an AI/ML-based inference operation of a terminal.

Referring to FIG. 6 and FIG. 7, a terminal may report its terminal capability information for an AI/ML-based inference operation to a base station (S710). The terminal capability information may include resource-related information for AI/ML-based inference of the terminal. For example, the terminal capability information may include at least one of a total number of APUs, a total number of C-PUs, a total number of AMUs or AMU occupancy, or resource requirement information for each intelligent functionality. Here, the resource requirement information may include information on a required number of APUs, a required number of C-PUs, or a required number of AMUs for each intelligent functionality.

According to an exemplary embodiment, the terminal capability information may include information on types of intelligent functionalities supported by the terminal, a type of AI/ML-based inference, or a number of inference operations that may be simultaneously performed. According to an exemplary embodiment, the terminal capability information may include size, inference latency, or power consumption information of an AI/ML model supported by the terminal. The terminal may report the terminal capability information including the above-described information to the base station using a higher layer message (e.g., radio resource control (RRC) message).

The base station may request an AI/ML-based inference operation for a specific intelligent functionality from the terminal based on the terminal capability information received from the terminal (S720). The specific intelligent functionality may include channel state information reporting, terminal location measurement (i.e., positioning), or beam management. The base station may transmit the inference operation request to the terminal using a higher layer message (e.g., RRC message).

The terminal may determine whether an inference operation can be performed for the corresponding intelligent functionality based on the received inference operation request (S730). The terminal may determine whether an AI/ML-based inference operation can be performed for the corresponding intelligent functionality based on currently available APUs among the total APUs.

According to an exemplary embodiment, the terminal may compare a required number of APUs for performing the inference operation for the corresponding intelligent functionality with a number of currently available APUs, and may determine whether the inference operation can be performed for the corresponding intelligent functionality based on a comparison result. For example, when the required number of APUs is less than or equal to the number of currently available APUs, the terminal may determine that the inference operation can be performed for the corresponding intelligent functionality.

According to an exemplary embodiment, the base station may transmit an AI/ML-based inference operation request including priority information for a specific intelligent functionality to the terminal. The terminal may determine whether an inference operation can be performed for the corresponding intelligent functionality based on the priority information of the inference operation request. For example, the terminal may compare priority information of a currently performed inference operation with the priority information of the inference operation request. When the priority of the inference operation request is higher than the priority of the currently performed inference operation, the terminal may determine that the inference operation can be performed for the corresponding intelligent functionality.

According to an exemplary embodiment, the terminal may receive a plurality of inference operation requests from the base station. The terminal may determine whether an inference operation can be performed or determine an execution order for each inference operation request based on priority information of each of the plurality of inference operation requests. For example, the terminal may sort the plurality of inference operation requests based on the priority information. The terminal may determine a required number of APUs for each inference operation request according to a sorted order. The terminal may determine whether the corresponding inference operation can be performed by comparing the determined required number of APUs with the number of currently available APUs. According to an exemplary embodiment, when the terminal receives the plurality of inference operation requests from the base station, the terminal may determine to perform at least two inference operations simultaneously based on the number of currently available APUs.

When it is determined that the inference operation can be performed, the terminal may allocate resources for the inference operation. For example, the terminal may allocate at least one APU among the currently available APUs to the corresponding inference operation. The terminal may increase APU occupancy based on the APUs allocated to the inference operation (S740). For example, the terminal may increase the number of APUs occupied for the inference operation among the total APUs.

According to an exemplary embodiment, when it is determined that execution of the inference operation is possible, the terminal may report inference operation availability information or APU occupancy state change information (e.g., APU occupancy change information) to the base station. The terminal may transmit the information to the base station using an RRC message. According to an exemplary embodiment, when it is determined that the inference operation cannot be performed, the terminal may also report inference operation unavailability information to the base station.

The base station may transmit at least one reference signal (RS) required for the terminal to perform the specific intelligent functionality according to the above-described inference operation request to the terminal (S750). According to an exemplary embodiment, the base station may transmit the reference signal to the terminal based on reception of the inference operation availability information or the APU occupancy state change information from the terminal. The reference signal may include at least one of CSI-RS for channel state information measurement of the terminal, a tracking reference signal (TRS) for beam management of the terminal, a demodulation reference signal (DMRS), or a positioning reference signal (PRS) for location measurement of the terminal.

The terminal may perform the AI/ML-based inference operation using at least one APU allocated to the inference operation based on at least one reference signal received from the base station (S760). The terminal may process the inference operation of the intelligent functionality based on AI/ML model parameters loaded for the corresponding inference operation and the reference signal received from the base station using the at least one APU.

The terminal may report an inference result for the intelligent functionality to the base station (S770). After reporting the inference result to the base station, the terminal may deallocate resources allocated for the inference operation. For example, after reporting the AI/ML-based inference result, the terminal may transition APU(s) occupied for the inference operation to an idle state (or an available state). The terminal may decrease APU occupancy based on a state transition of the APU(s) (S780). For example, the terminal may increase the number of currently available APUs among the total APUs.

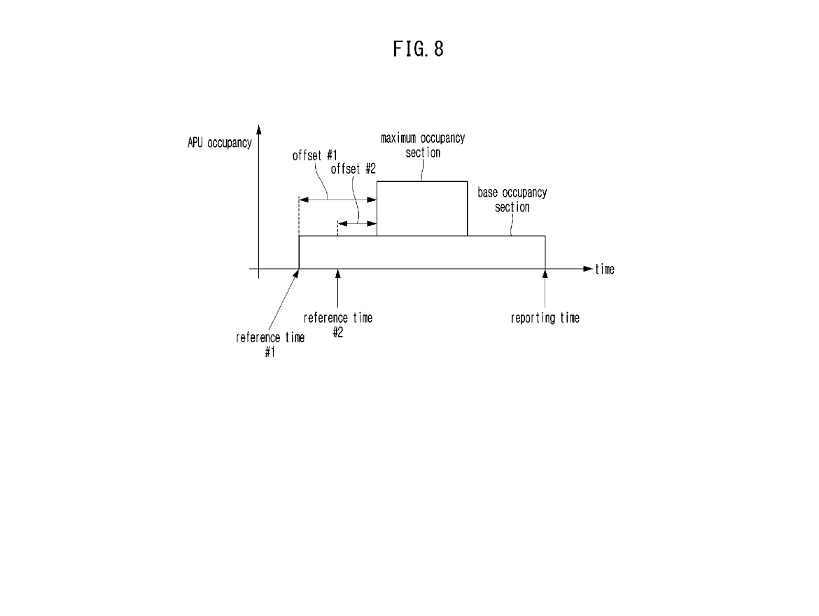

FIG. 8 is a conceptual diagram illustrating an exemplary embodiment of a change in APU occupancy according to an AI/ML-based inference operation of a terminal.

Referring to FIG. 8, a terminal may have APU occupancy at different levels over time while performing an AI/ML-based inference operation. The APU occupancy may include a base occupancy section and a maximum occupancy section. The base occupancy section may be a section in which APU occupancy required while an inference computation function of an APU is activated is applied, and the maximum occupancy section may be a section in which relatively high APU occupancy required while the inference operation of the APU is performed is applied. According to an exemplary embodiment, the base occupancy section may be defined as a section having a duration from a first reference time to a reporting time. The maximum occupancy section may be defined as a section having a preset duration starting at a time delayed by a predetermined time from one of a first reference time or a second reference time as a start time. Here, the first reference time may be a triggering time of an AI/ML-based inference operation of the base station, for example, a time at which the base station requests the inference operation from the terminal. The second reference time may be the last reception time of a reference signal transmitted from the base station. The reporting time may be a time at which the terminal reports a result of the inference operation performed through the APU to the base station. According to an exemplary embodiment, the first reference time may be a first symbol time of a periodic/semi-persistent CSI-RS transmission time for a corresponding report during semi-persistent CSI reporting. Also, a start time of the maximum occupancy section may be a time delayed by a first offset from the first reference time, or may be a time delayed by a second offset from the second reference time.

According to an exemplary embodiment, the terminal may report, to the base station, information on an increase of the maximum occupancy section and information on a duration of the maximum occupancy section (or an end time of the maximum occupancy section), together with the base APU occupancy, in order to represent APU occupancy that changes over time.

According to an exemplary embodiment, when an AI/ML-based inference operation is performed (i.e., when an APU resource is used in the maximum occupancy section), APU occupancy of the base occupancy section may be set to 0. The terminal may occupy the APU resource in the maximum occupancy section and may release the APU resource in a time section after the maximum occupancy section ends.

According to an exemplary embodiment, when the AI/ML-based inference operation of the terminal does not require APU occupancy, an increase amount of the maximum occupancy section may be set to 0. In this case, the terminal may assume that APU resources are occupied in the base occupancy section, and may release the APU resources in a time section after the base occupancy section ends.

According to an exemplary embodiment, multiple maximum occupancy sections may be configured within the base occupancy section. For example, the terminal may simultaneously perform a plurality of AI/ML inference operations using a plurality of APUs. In this case, the maximum occupancy section of each of the plurality of APUs may be defined based on different reference times, offsets, or durations within the base occupancy section.

According to an exemplary embodiment, the terminal may report at least one of APU occupancy, the base occupancy section, the maximum occupancy section, or offset information for each intelligent functionality to the base station based on a control signal received from the base station. Also, the terminal may report at least one of the APU occupancy, the base occupancy section, the maximum occupancy section, or offset information for each intelligent functionality to the base station based on preconfigured information.

In FIG. 8, a change in APU occupancy according to an AI/ML-based inference operation is described, but a change in C-PU occupancy according to the AI/ML-based inference operation may be the same. In other words, the terminal may report at least one of C-PU occupancy, a base occupancy section, a maximum occupancy section, or offset information for each intelligent functionality to the base station based on a control signal received from the base station. Also, the terminal may report at least one of the C-PU occupancy, the base occupancy section, the maximum occupancy section, or the offset information for each intelligent functionality to the base station based on preconfigured information.

In addition, the terminal may report, to the base station, at least one of information for determining a CSI reporting time, for example, information on a non-AI/ML inference operation time or information on an additional time (or a number of additional symbols) required in addition to the inference operation time.

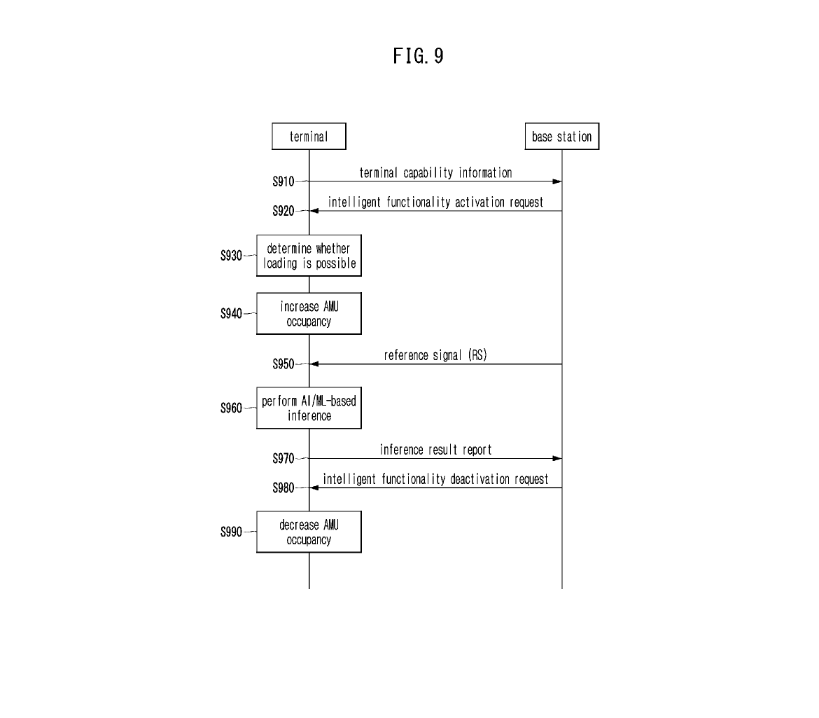

FIG. 9 is a sequence diagram illustrating another exemplary embodiment of a resource management method for an AI/ML-based inference operation of a terminal.

Referring to FIG. 6 and FIG. 9, a terminal may report its terminal capability information for an AI/ML-based inference operation to a base station (S910). The terminal capability information may include resource-related information for AI/ML-based inference of the terminal. For example, the terminal capability information may include at least one of a total number of APUs, a total number of C-PUs, a total number of AMUs, or resource occupancy requirement information for each intelligent functionality. Here, the resource occupancy requirement information may include information on a required number of APUs, a required number of C-PUs, or a required number of AMUs for each intelligent functionality.

According to an exemplary embodiment, the terminal capability information may include information on types of intelligent functionalities supported by the terminal, a type of AI/ML-based inference, or a number of inference operations that may be simultaneously performed. According to an exemplary embodiment, the terminal capability information may include size, inference latency, or power consumption information of an AI/ML model supported by the terminal. The terminal may report the terminal capability information including the above-described information to the base station using a higher layer message (e.g., RRC message).

The base station may request activation of a specific intelligent functionality of the terminal for an AI/ML-based inference operation based on the received terminal capability information (S920). The specific intelligent functionality may include channel state information reporting, terminal location measurement (i.e., positioning), or beam management.

According to an exemplary embodiment, an activation request of an intelligent functionality from the base station may correspond to a step of requesting an AI/ML-based inference operation from a base station described with reference to FIG. 7. The activation request of the intelligent functionality may include an AI/ML inference operation request for the intelligent functionality or priority information for the intelligent functionality. The base station may transmit the activation request to the terminal using a higher layer message (e.g., RRC message).

The terminal may determine whether loading of AI/ML model parameters related to the corresponding intelligent functionality is possible based on the received activation request (S930). The terminal may determine whether loading of at least one AI/ML model parameter required for an inference operation of the corresponding intelligent functionality is possible based on currently available AMUs among the total AMUs. According to an exemplary embodiment, when currently available APUs exist, the terminal may determine whether loading of model parameters for an inference operation using the corresponding APUs is possible.

According to an exemplary embodiment, the terminal may compare a required AMU occupancy for loading the model parameters for the corresponding intelligent functionality with a currently available AMU occupancy, and may determine whether loading of model parameters for inference of the corresponding intelligent functionality is possible based on a comparison result. For example, when the required AMU occupancy is less than or equal to the currently available AMU occupancy, the terminal may determine that loading of the model parameters is possible.

According to an exemplary embodiment, the terminal may determine a loading priority for a plurality of model parameters based on priority information of the activation request of the intelligent functionality. The terminal may compare AMU occupancy required for a model parameter having the highest priority among the plurality of model parameters with currently available AMU occupancy. The terminal may determine whether loading of the model parameters is possible based on a comparison result.

According to an exemplary embodiment, the terminal may sequentially attempt to load model parameters from a model parameter having the highest priority among a plurality of model parameters based on priority information of the activation request. In this case, when available AMU resources, that is, available occupancy is insufficient, the terminal may defer loading of model parameters having a lower priority.

When it is determined that loading of the AI/ML model parameters is possible, the terminal may allocate memory resources for the AI/ML-based inference operation. For example, the terminal may allocate at least one AMU among the currently available AMUs for loading of the AI/ML model parameters. The terminal may increase AMU occupancy based on the allocated AMUs (S940). For example, the terminal may increase a number of AMUs allocated for model parameter loading among the total AMUs.

According to an exemplary embodiment, the terminal may report model parameter loading availability information or AMU occupancy state change information (e.g., AMU occupancy change information) to the base station. The terminal may transmit the information to the base station using an RRC message. According to an exemplary embodiment, when it is determined that loading of the model parameters is not possible, the terminal may also report information indicating this to the base station.

The base station may transmit at least one reference signal required for activating a specific intelligent functionality and performing an inference operation according to the activation request to the terminal (S950). According to an exemplary embodiment, the base station may transmit the reference signal to the terminal based on receiving the model parameter loading availability information or the AMU occupancy state change information from the terminal. The reference signal may include at least one of CSI-RS for channel state information measurement of the terminal, TRS for beam management of the terminal, DMRS, or PRS for location measurement (i.e., positioning) of the terminal.

The terminal may perform the AI/ML-based inference operation using at least one APU based on the model parameters loaded in the AMU based on at least one reference signal received from the base station (S960). Here, the APUs used for the inference operation may be at least one of the currently available APUs. The terminal may process the inference operation of the intelligent functionality based on the AI/ML model parameters loaded in the AMU and the reference signal received from the base station using the APU(s).

The terminal may report an inference result for the intelligent functionality to the base station (S970). After receiving the inference result from the terminal, the base station may transmit a deactivation request for the previously requested intelligent functionality to the terminal (S980).

The terminal may deallocate resources allocated for the inference operation based on the received deactivation request of the intelligent functionality. For example, the terminal may transition APUs occupied for the inference operation to an idle state (or an available state). The terminal may release AMU occupancy associated with the model parameters used by the corresponding APU(s). Here, release of the model parameters may indicate unloading of the AI/ML model parameters from the AMU. The terminal may decrease AMU occupancy based on release of AMU occupancy associated with the model parameters (S990). For example, the terminal may increase the currently available AMU occupancy among total AMU occupancy.

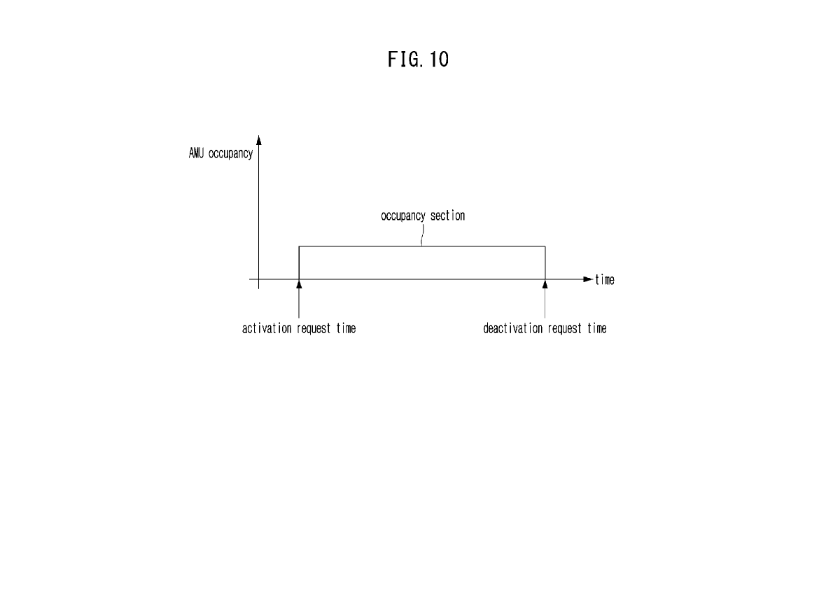

FIG. 10 is a conceptual diagram illustrating an exemplary embodiment of a change in AMU occupancy according to an AI/ML-based inference operation of a terminal.

Referring to FIG. 10, a model parameter occupancy section (or time) of an AMU may be defined based on a time at which a functionality activation request is received from the base station (i.e., activation request time) and a time at which a functionality deactivation request is received from the base station (i.e., deactivation request time). The terminal may determine loading of model parameters or AMU occupancy based on the time of the functionality activation request, and may determine unloading of the model parameters or release of AMU occupancy based on the time of the functionality deactivation request.

According to an exemplary embodiment, a model parameter occupancy section may be defined differently for each intelligent functionality. The base station may define a model parameter occupancy section for each intelligent functionality and may transmit the model parameter occupancy section to the terminal using an RRC message or the like. Also, the terminal may define a model parameter occupancy section for a specific intelligent functionality, that is, an intelligent functionality corresponding to a functionality activation request from the base station, and may report the model parameter occupancy section to the base station through terminal capability reporting.

According to an exemplary embodiment, the terminal may dynamically manage AMU occupancy during a model parameter occupancy section. For example, in a state where AI/ML model parameters are loaded in the AMU, the terminal may receive a new inference operation request for the corresponding AI/ML model parameters from the base station. The terminal may reconfigure the model parameter occupancy section based on a reception time of the inference operation request. In other words, the terminal may extend or readjust the expiration time of the previously configured model parameter occupancy section so that AMU resources may continue to be occupied while the corresponding model parameters are required.

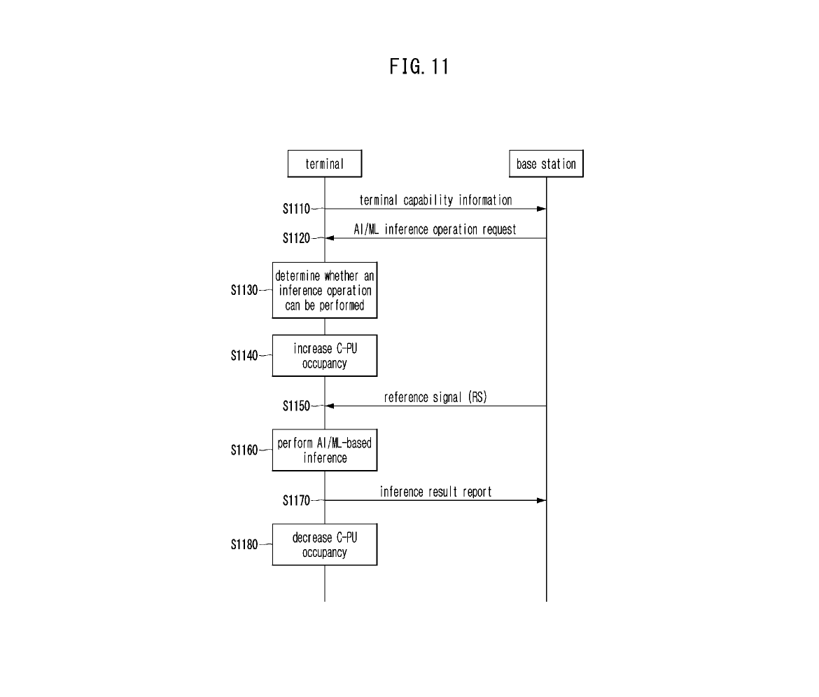

FIG. 11 is a sequence diagram illustrating another exemplary embodiment of a resource management method for an AI/ML-based inference operation of a terminal.

Referring to FIG. 11, a terminal may perform an AI/ML-based inference operation using a general-purpose processor (e.g., the first processor of FIG. 6) rather than a dedicated processor (e.g., the second processor of FIG. 6) for performing intelligent functionalities. The terminal may report its terminal capability information for the AI/ML-based inference operation to the base station (S1110). The terminal capability information may include resource-related information for AI/ML-based inference of the terminal. For example, the terminal capability information may include at least one of a total number of APUs, a total number of C-PUs, a total number of AMUs or AMU occupancy, or resource requirement information for each intelligent functionality. Here, the required resource information may include information on a required number of APUs, a required number of C-PUs, or a required number of AMUs for each intelligent functionality. According to an exemplary embodiment, the terminal capability information may further include at least one of information on types of intelligent functionalities supported by the processor, information on a type of AI/ML-based inference, information on a number of inference operations, AI/ML model parameter size information, inference latency information, or power consumption information. The terminal may report the terminal capability information including the above-described information to the base station using a higher layer message (e.g., RRC message).

The base station may request an AI/ML-based inference operation for a specific intelligent functionality from the terminal based on the terminal capability information received from the terminal (S1120). The specific intelligent functionality may include channel state information reporting, terminal location measurement (i.e., positioning), or beam management. The base station may transmit an inference operation request to the terminal using a higher layer message (e.g., RRC message).

The terminal may determine whether an inference operation can be performed for the corresponding intelligent functionality based on the received inference operation request (S1130). The terminal may determine whether the AI/ML-based inference operation can be performed for the corresponding intelligent functionality based on currently available C-PUs among the total C-PUs.

According to an exemplary embodiment, the terminal may compare a required number of C-PUs for performing the inference operation for the corresponding intelligent functionality with a number of currently available C-PUs, and may determine whether the inference operation can be performed for the corresponding intelligent functionality based on a comparison result. For example, when the required number of C-PUs is less than or equal to the number of currently available C-PUs, the terminal may determine that the inference operation can be performed for the corresponding intelligent functionality.

According to an exemplary embodiment, the base station may transmit an AI/ML-based inference operation request including priority information for a specific intelligent functionality to the terminal. The terminal may determine whether an inference operation can be performed for the corresponding intelligent functionality based on the priority information of the inference operation request. For example, the terminal may compare priority information of a currently performed inference operation with the priority information of the inference operation request. When the priority of the inference operation request is higher than the priority of the currently performed inference operation, the terminal may determine that the inference operation can be performed for the corresponding intelligent functionality.

According to an exemplary embodiment, the terminal may receive a plurality of inference operation requests from the base station. The terminal may determine whether an inference operation can be performed or determine an execution order for each inference operation request based on priority information for each of the plurality of inference operation requests. For example, the terminal may sort the plurality of inference operation requests based on the priority information. The terminal may determine a required number of C-PUs for each inference operation request according to a sorted order. The terminal may determine whether the corresponding inference operation can be performed by comparing the determined required number of C-PUs with the number of currently available C-PUs. According to an exemplary embodiment, when the terminal receives a plurality of inference operation requests from the base station, the terminal may determine to perform at least two inference operations simultaneously based on the number of currently available C-PUs.

When it is determined that the inference operation can be performed, the terminal may allocate resources for the inference operation. For example, the terminal may allocate at least one C-PU among the currently available C-PUs to the corresponding inference operation. The terminal may increase C-PU occupancy based on the C-PUs allocated to the inference operation (S1140). For example, the terminal may increase the number of C-PUs occupied for the inference operation.

According to an exemplary embodiment, when it is determined that execution of the inference operation is possible, the terminal may report inference operation availability information or C-PU occupancy state change information (e.g., C-PU occupancy change information) to the base station. The terminal may transmit the information to the base station using an RRC message. According to an exemplary embodiment, when it is determined that execution of the inference operation is not possible, the terminal may also report inference operation unavailability information to the base station.

The base station may transmit at least one reference signal required for performing the specific intelligent functionality based on the above-described inference operation request to the terminal (S1150). According to an exemplary embodiment, the base station may transmit the reference signal to the terminal based on receiving the inference operation availability information or the C-PU occupancy state change information from the terminal. The reference signal may include at least one of CSI-RS for channel state information measurement of the terminal, TRS for beam management of the terminal, DMRS, or PRS for location measurement of the terminal.

The terminal may perform the AI/ML-based inference operation using at least one C-PU allocated to the inference operation based on at least one reference signal received from the base station (S1160). The terminal may process the inference operation of the intelligent functionality based on the AI/ML model parameters loaded for the corresponding inference operation and the reference signal received from the base station using at least one C-PU.

The terminal may report an inference result for the intelligent functionality to the base station (S1170). After reporting the inference result to the base station, the terminal may deallocate resources allocated for the inference operation. For example, the terminal may transition C-PUs occupied for the inference operation to an idle state (or an available state). The terminal may decrease C-PU occupancy based on the state transition of the C-PU(s) (S1180). For example, the terminal may increase the number of currently available C-PUs.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. A method of a terminal, comprising:
receiving, from a base station, an artificial intelligence/machine learning (AI/ML)-based inference operation request for at least one intelligent functionality;
determining whether inference for the at least one intelligent functionality is performable based on the AI/ML-based inference operation request;
allocating at least one resource for performing the inference based on a determination that the inference is performable;
receiving at least one reference signal from the base station;
performing an AI/ML-based inference operation using the allocated at least one resource based on the reference signal; and
reporting a result of the AI/ML-based inference operation to the base station.

2. The method of claim 1, wherein the determining of whether the inference is performable comprises:
comparing a required number of AI/ML processing units (APUs) for performing the inference with a number of currently available APUs based on the AI/ML-based inference operation request; and
determining that the inference for the at least one intelligent functionality is performable based on the required number of APUs being less than or equal to the number of currently available APUs.

3. The method of claim 2, wherein the allocating of the at least one resource comprises:
allocating, from among the currently available APUs, the required number of APUs as a resource for performing the inference; and
increasing an APU occupancy based on the allocated resource.

4. The method of claim 1, wherein the determining of whether the inference is performable comprises:
comparing a required AI/ML memory unit (AMU) occupancy for performing the inference with a currently available AMU occupancy based on the AI/ML-based inference operation request; and
determining that loading of at least one AI/ML model parameter for the at least one intelligent functionality is performable based on the required AMU occupancy being less than or equal to the currently available AMU occupancy.

5. The method of claim 4, wherein the allocating of the at least one resource comprises:
allocating, from the currently available AMU occupancy, the required AMU occupancy as a resource for performing the inference;
loading the at least one AI/ML model parameter into an AMU based on the allocated resource; and
increasing an AMU occupancy based on the allocated resource.

6. The method of claim 1, wherein the determining of whether the inference is performable comprises:
comparing a required number of CSI processing units (C-PUs) for performing the inference with a number of currently available C-PUs based on the AI/ML-based inference operation request; and
determining that the inference for the at least one intelligent functionality is performable based on the required number of C-PUs being less than or equal to the number of currently available C-PUs.

7. The method of claim 6, wherein the allocating of the at least one resource comprises:
allocating, from among the currently available C-PUs, the required number of C-PUs as a resource for performing the inference; and
increasing a C-PU occupancy based on the allocated resource.

8. The method of claim 1, wherein the determining of whether the inference is performable comprises:
comparing a priority of the AI/ML-based inference operation request with a priority of an inference operation currently being performed; and
determining that the inference according to the AI/ML-based inference operation request is performable based on the priority of the AI/ML-based inference operation request being higher than the priority of the inference operation currently being performed.

9. The method of claim 1, further comprising: reporting terminal capability information to the base station,
wherein the terminal capability information includes at least one of information on a total number of APUs, information on a total number of C-PUs, information on a total number of AMUs, or intelligent functionality-specific resource requirement information.

10. The method of claim 1, further comprising, after reporting the result of the inference operation to the base station:
releasing the at least one resource; and
increasing a currently available resource occupancy based on the released at least one resource.

11. A terminal comprising at least one processor, wherein the at least one processor causes the terminal to perform:
receiving, from a base station, an artificial intelligence/machine learning (AI/ML)-based inference operation request for at least one intelligent functionality;
determining whether inference for the at least one intelligent functionality is performable based on the AI/ML-based inference operation request;
allocating at least one resource for performing the inference based on a determination that the inference is performable;
receiving at least one reference signal from the base station;
performing an AI/ML-based inference operation using the allocated at least one resource based on the reference signal; and
reporting a result of the AI/ML-based inference operation to the base station.

12. The terminal of claim 11, wherein in the determining of whether the inference is performable, the at least one processor causes the terminal to perform:
comparing a required number of AI/ML processing units (APUs) for performing the inference with a number of currently available APUs based on the AI/ML-based inference operation request; and
determining that the inference for the at least one intelligent functionality is performable based on the required number of APUs being less than or equal to the number of currently available APUs.

13. The terminal of claim 12, wherein in the allocating of the at least one resource, the at least one processor causes the terminal to perform:
allocating, from among the currently available APUs, the required number of APUs as a resource for performing the inference; and
increasing an APU occupancy based on the allocated resource.

14. The terminal of claim 11, wherein in the determining of whether the inference is performable, the at least one processor causes the terminal to perform:
comparing a required AI/ML memory unit (AMU) occupancy for performing the inference with a currently available AMU occupancy based on the AI/ML-based inference operation request; and
determining that loading of at least one AI/ML model parameter for the at least one intelligent functionality is performable based on the required AMU occupancy being less than or equal to the currently available AMU occupancy.

15. The terminal of claim 14, wherein in the allocating of the at least one resource, the at least one processor causes the terminal to perform:
allocating, from the currently available AMU occupancy, the required AMU occupancy as a resource for performing the inference;
loading the at least one AI/ML model parameter into an AMU based on the allocated resource; and
increasing an AMU occupancy based on the allocated resource.

16. The terminal of claim 11, wherein in the determining of whether the inference is performable, the at least one processor causes the terminal to perform:
comparing a required number of CSI processing units (C-PUs) for performing the inference with a number of currently available C-PUs based on the AI/ML-based inference operation request; and
determining that the inference for the at least one intelligent functionality is performable based on the required number of C-PUs being less than or equal to the number of currently available C-PUs.

17. The terminal of claim 16, wherein in the allocating of the at least one resource, the at least one processor causes the terminal to perform:
allocating, from among the currently available C-PUs, the required number of C-PUs as a resource for performing the inference; and
increasing a C-PU occupancy based on the allocated resource.

18. The terminal of claim 11, wherein in the determining of whether the inference is performable, the at least one processor causes the terminal to perform:
comparing a priority of the AI/ML-based inference operation request with a priority of an inference operation currently being performed; and
determining that the inference according to the AI/ML-based inference operation request is performable based on the priority of the AI/ML-based inference operation request being higher than the priority of the inference operation currently being performed.

19. The terminal of claim 11, wherein the at least one processor further causes the terminal to perform: reporting terminal capability information to the base station,
wherein the terminal capability information includes at least one of information on a total number of APUs, information on a total number of C-PUs, information on a total number of AMUs, or intelligent functionality-specific resource requirement information.

20. The terminal of claim 11, wherein the at least one processor further causes the terminal to perform, after reporting the result of the inference operation to the base station:
releasing the at least one resource; and
increasing a currently available resource occupancy based on the released at least one resource.
